(19) United States
(12) Patent Application Publication
(10) Pub. No.: US 2006/0070777 A1
(43) Pub. Date: Apr. 6, 2006

(54) Small diameter split-rim drive wheel geared hub

(76) Inventor: Leonard Ducharme, American Fork, UT (US)

Correspondence Address: THORPE NORTH & WESTERN, LLP., 8180 SOUTH 700 EAST, SUITE 200, SANDY, UT, 84070, US

(21) Appl. No.: 10/958,152

(22) Filed: Oct. 4, 2004

(51) Int. Cl. B60K 1/00

(52) U.S. Cl. 180/65.1

(57) ABSTRACT

A drive wheel includes a pneumatic tire, a substantially solid split rim wheel configured to receive the pneumatic tire, and a geared hub with an internal transmission with multiple selectable speeds. The split rim wheel includes opposing side portions, and the geared hub is disposed between the opposing side portions of the split rim.

### BACKGROUND

1. Field of the Invention

The present invention relates generally to drive wheels for small motorized vehicles. More particularly, the present invention relates to a small diameter split rim drive wheel with an internal geared hub transmission.

2. Related Art

Small motorized vehicles, such as motorized scooters, mini bikes, and the like, have been used for many years. Some of these are powered by internal combustion engines, while others are electrically powered. The popularity and affordability of these vehicles has increased dramatically in recent years. With this increase in popularity has come many advances in technology and configuration changes, some of which make them more powerful, versatile and desirable for consumers.

Nevertheless, certain design and configuration challenges remain, and some of these challenges are compounded by practical limitations of size and weight. Lightweight motorized vehicles naturally tend to present certain compromises because of size, weight, and cost. For example, the size and weight of electric storage batteries greatly influence the total power output and operating range/duration of electric vehicles. A similar challenge is presented by vehicles with internal combustion engines. The maximum legal engine size for these vehicles can be limited by local ordinances, and practical considerations of size, weight, and handleability can also limit engine size.

For these and other reasons, many of these vehicles tend to be under-powered. For example, because of their small engine or motor size, many small scooters and minibikes have relatively low peak power output, and can lug down or simply stall out on a hill, depending upon the weight of the rider and the grade of the hill. Unfortunately, providing additional power to prevent this generally requires either a more powerful engine, or some other device, such as a multi-speed transmission, for providing additional mechanical advantage. Unfortunately, a larger motor will tend to increase the size and weight of the vehicle, which will further increase the need for more power, creating a vicious cycle. Moreover, existing multi-speed transmission systems that are configured for use with small motorized vehicles tend to be bulky and heavy, and also add to the complexity of the vehicle.

Another consideration for small motorized vehicles relates to the tires and drive wheels. Small diameter tires for motorized vehicles are generally too thick compared to their diameter to allow them to be press-mounted directly onto a single piece wheel rim in the manner of most bicycle and automobile tires. That is, the thickness of the tire relative to its size and shape substantially prevents mounting on a single piece rim because the tire does not have enough flexibility to deform around the rim. Consequently, split rims are frequently used.

### SUMMARY

It has been recognized that it would be advantageous to develop a small motorized vehicle with a multi-speed transmission that is compact and does not add significant weight to the vehicle.

It has also been recognized that it would be advantageous to develop a multi-speed transmission for a small motorized vehicle that does not require additional external structure on the vehicle.

In accordance with one aspect thereof, the invention provides a drive wheel including a pneumatic tire, a substantially solid split rim wheel configured to receive the pneumatic tire, and a geared hub with an internal transmission with multiple selectable speeds. The split rim wheel includes opposing side portions, and the geared hub is disposed between the opposing side portions of the split rim.

In accordance with another aspect thereof, the invention provides a drive wheel for a small motorized vehicle, including a hub, having a rotational axis, and an internal transmission configured to provide multiple selectable transmission ratios, a drive coupler, attached to the hub, configured to transmit a driving torque from the vehicle to the hub, a split rim, having divided rim portions, coupled to the hub and configured to rotate about the rotational axis, and a tire, mounted between the divided portions of the split rim.

In accordance with yet another aspect thereof, the invention provides a motorized vehicle, comprising a motor and a drive wheel. The drive wheel includes an axle, a hub, rotatably disposed upon the axle, means for transmitting rotational driving motion from the motor to the hub, a split rim wheel, disposed upon the hub, having divided portions, and a tire, mounted between the divided portions of the split rim. The hub includes an internal multi-speed transmission, and the divided portions of the split rim enclose the hub and are configured to rotate therewith.

In accordance with still another aspect thereof, the invention provides a drive wheel for a motorized vehicle. The drive wheel includes a pneumatic tire, having a wall thickness relative to a size thereof such that mounting upon a single-piece rim via deformation of the tire is substantially prevented. The drive wheel also includes a vertically split rim, having separable sides configured to be mechanically fastened together to mount the tire thereto, and a hub, disposed between the opposing sides of the split rim, having an internal transmission with multiple speeds.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and, wherein:

FIG. 1 is a cross-sectional view of one embodiment of a small diameter drive wheel including a split rim with an internal geared hub, in accordance with the present invention;

FIG. 2 is a perspective view of a small motorized scooter incorporating the drive wheel of FIG. 1;

FIG. 3 is a cross-sectional view of an alternative embodiment of a small diameter drive wheel including a split rim and semi-cylindrical collar pieces disposed around the internal geared hub;

FIG. 4 is a front side view of the drive wheel of FIG. 3;

FIG. 5 is a cross-sectional view of another alternative embodiment of a small diameter split rim drive wheel comprising wheel quarters disposed around the internal geared hub;

FIG. 6A is a front side view of the drive wheel of FIG. 5; and

FIG. 6B is a back side view of the drive wheel of FIG. 5.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The invention advantageously combines a geared hub with a small diameter split-rim wheel, and enables light, motorized vehicles with very small wheels to employ a multi-speed transmission in a very small package. The invention is particularly suited for small powered scooters, minibikes, etc., but is not limited to these.

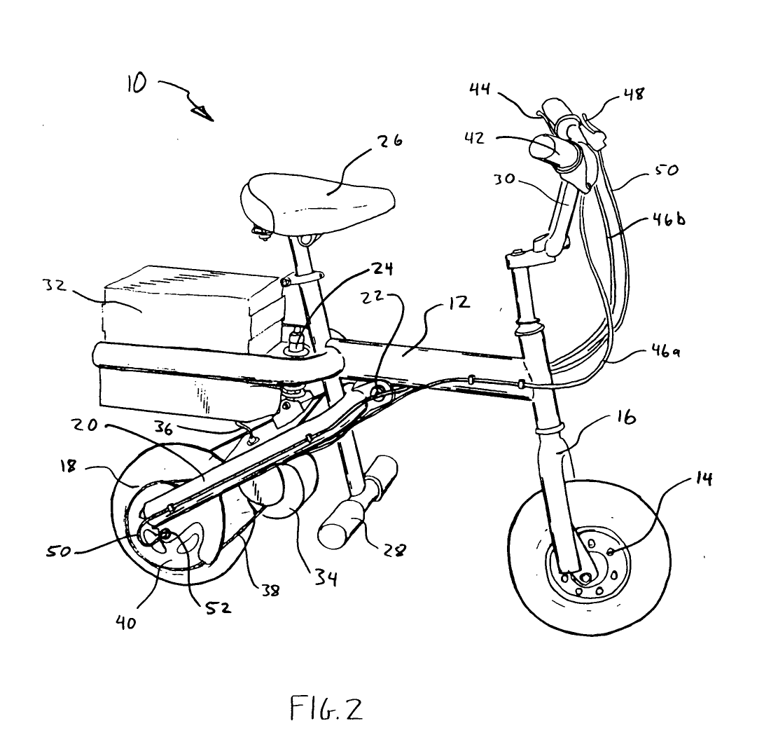

One example of a small minibike which employs a drive wheel in accordance with the present invention is shown in FIG. 2. A vehicle similar to the one depicted in FIG. 2 is available from Pukka USA, LLC of American Fork, Utah. The minibike 10 is electrically powered, and generally comprises a rigid tubular frame 12, with a front wheel 14 attached to steerable front forks 16, and a rear drive wheel 18 attached to a drive wheel linkage 20. The drive wheel linkage is pivotally connected to the frame at pivot 22, and is biased away from the frame via a coil spring/shock absorber 24. The vehicle includes features that allow a user to mount and steer it, including a seat 26, foot rests 28, and handlebars 30 that are attached above the front forks.

A battery pack 32 is supported on a rear portion of the frame 12, and an electric motor 34 is attached to the drive wheel linkage 20. The motor draws electrical power from the battery via a power cord 36, and provides mechanical power to the rear drive wheel 18 via a chain 38 that is disposed around a sprocket 40 that is attached to the drive wheel. Controls for the vehicle are included on the handlebars 30, and include a throttle control 42 and a brake lever 44. These controls are interconnected to the motor and brakes (not shown), respectively, via control cables 46a, 46b, to allow the user to control the motor and brakes.

The vehicle depicted in FIG. 2 falls into a class generally referred to as “light motorized vehicles.” As used herein, the term “small motorized vehicle” is intended to encompass this class of vehicles. Such vehicles are generally classified according to their engine size, power output, and/or maximum speed. For example, for gasoline powered vehicles in this category, an engine size limit of 50 cc is the general rule. Electric vehicles in this category are generally limited to a maximum power output of 750 watts. A maximum allowed speed of 25 mph is typical. Indeed, these types of vehicles are generally street legal in most states and localities in the United States on streets that have a speed limit of 25 mph or lower. Regulations regarding licensure and operation of these vehicles also vary from place to place. Unlike automobiles and motorcycles, these vehicles may not need to be registered with a department of motor vehicles for legal use on the streets. As for operation, in some states, possession of a standard motor vehicle operator's license is required. In other places, licensure is not required, though age limitations (e.g. operators must be at least 14 years of age), helmet laws, adult supervision laws, and other restrictions may apply. Given the relative freedom of use and limited regulation, these types of vehicles can be very desirable for frequent short distance travel at relatively low speed.

As noted above, small vehicles such as the one shown in FIG. 2 are subject to certain design considerations because of their size. For example, it can be seen that unless the frame were significantly modified and enlarged, the vehicle 10 in FIG. 2 provides few locations where additional structure, such as a geared transmission, could be attached. Nevertheless, it would be desirable for this vehicle to have a multi-speed transmission to allow it to provide higher torque to the drive wheel at lower speeds.

Advantageously, the vehicle 10 shown in FIG. 2 also includes a multi-speed transmission disposed within the drive wheel 18. The transmission (not visible in FIG. 2) is controlled by a gear shift lever 48 attached to the handlebars 30, with a gear shift cable 50 extending to the rear axle 52. The drive wheel transmission allows a user to select from multiple gear ratios, allowing more efficient power usage and greater torque at lower speeds when needed.

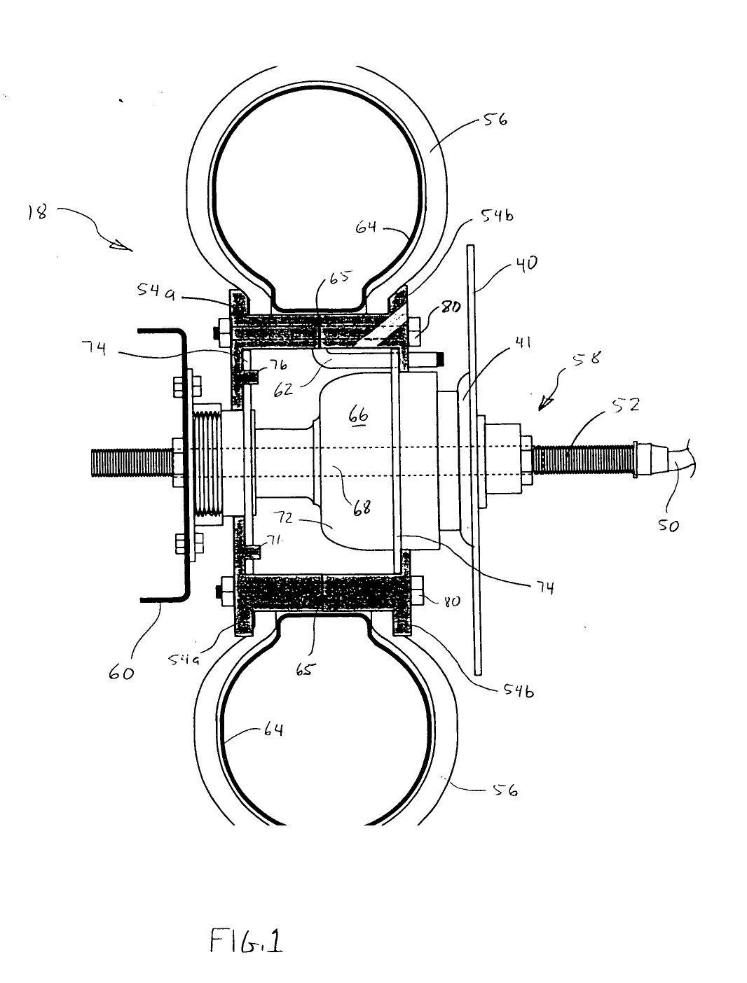

In order to place a transmission inside the rear wheel, the invention secures a small (e.g. 4″ dia.) two-piece solid wheel rim to a geared hub. The geared hub can be similar to a bicycle-type geared hub, but modified for use with a split rim. A cross-sectional view of one embodiment of the small diameter split-rim drive wheel 18 is provided in FIG. 1. This drive wheel comprises a substantially solid split rim 54 with opposing side portions 54a, 54b. The term “substantially solid” as used herein is intended to distinguish this rim from rims having wire spokes, such as a conventional bicycle rim. It is not intended to suggest that the wheel rim pieces must be entirely solid, without openings or spaces of any kind. These types of rims can be made of a variety of materials, including metals and polymers. The inventor has successfully used split rims of injection-molded polymer material.

The split rim 54 is configured to receive a pneumatic tire 56, and is mounted on an axle assembly 58 that is affixed to the drive wheel linkage (20 in FIG. 2) of the vehicle frame. Also attached to the axle assembly are the drive sprocket 40 and a brake drum 60. The brake drum is configured to have a band or strap (not shown) wrapped around its perimeter, configured such that mechanical constriction of the band provides friction against the drum to slow the drive wheel. Other brake systems and configurations can also be used. Because most geared hubs that are currently available are not configured to accommodate tires wider than 2.5″, a sprocket extension 41 is provided to space the sprocket away from the center of the wheel to allow passage of the drive chain (38 in FIG. 2) past the tire. Similarly, a brake drum extension 61 is provided to move the brake drum away from the center of the geared hub to allow clearance of the brake band or strap (not shown).

The rim 54 is of the type that is intended to fit small but relatively thick tires. The rim may range from about 3″ to 8″ in diameter (measured at the smallest diameter outer portion, between the wheel rim flanges), and is configured to fit tires ranging from about 8″ to 15″ in diameter (outside diameter). Because of the need for high strength and wear characteristics, such small diameter tires for motorized vehicles are generally too thick compared to their diameter to allow them to be press-mounted directly onto a single piece wheel rim in the manner of most bicycle and automobile tires. The size and thickness simply do not provide enough flexibility to allow them to be deformed around a rim. Consequently, the split rim is used, allowing the tire 56 to be sandwiched between opposing halves 54a, 54b of the rim. As shown in FIG. 1, the tire includes a valve stem 62 that communicates with the interior of the tire and allows inflation thereof. The air valve can pass through a notch (not shown) in one of the flanges in the geared hub. The tire can be a tubeless type, or can include an inner tube 64, as shown in FIG. 1. Where a tubeless tire is used, a resilient o-ring 65 can be sandwiched in a groove between the two wheel rim halves, to provide an air-tight seal and prevent deflation of the tire.

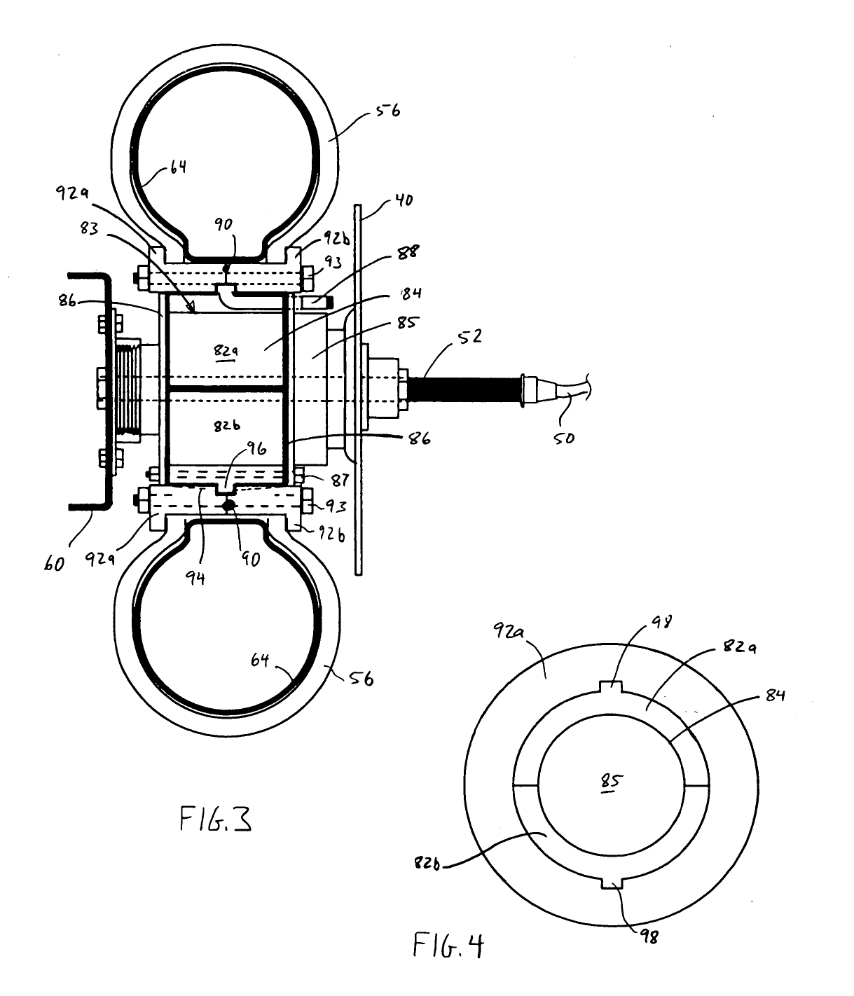

The two wheel rim halves 54a, 54b, are specially configured to fit tightly around and mate with a compact geared hub 66. This type of geared hub includes an internal gear system with selectable gear ratios, similar to geared hubs that are used for bicycles, but modified to mount to a split rim wheel, as described herein. Suitable geared hubs of this type are available in 3, 5, and 7 speed varieties, and are commercially available from manufacturers such as Shimano (e.g. the Nexxus 3-speed hub), Schram (e.g. the T-3 hub), and Sturmey-Archer (e.g. the AW 300 hub). The type of geared hub depicted in FIG. 1 is like the Nexxus 3 speed hub by Shimano. The geared hub 85 depicted in FIGS. 3 and 4 is similar to the Sturmey-Archer AW 300 hub.

Those skilled in the art will be familiar with the principles of operation and component parts of these types of geared hubs, and all related parts are not shown in the figures herein. Only a general description of one of several configurations of these devices will be provided here. In one embodiment, the geared hub 66 includes an axle 68 that is configured to be rigidly affixed to the vehicle frame (i.e. the drive wheel linkage 20), with a sun gear (not shown) in the interior of the hub and affixed to the axle. An inner sleeve (not shown) is rotatably disposed on the axle, and affixed to the sprocket 40. Within the hub, the inner sleeve supports a plurality of sets (e.g. one per speed of the device) of planet gears (not shown) that turn with the sprocket and mesh with the fixed sun gear. The planet gears also mesh with gear teeth (not shown) formed on the inside of the outer hub cylinder 72. The outer hub cylinder is also rotatably disposed upon the axle, and affixed to the wheel rim halves, as noted above. Thus, as the sprocket turns, the planet gears transfer rotational energy to the outer hub cylinder, and thus rotate the wheel rim.

The speed of rotation of the outer hub 72 relative to the rotational speed of the sprocket 40 depends upon the gear ratio between the sun gear and the planet gears. A plunger or comparable device (not shown) is associated with the axle 68, and is configured to move the sun gear laterally across the axle so as to selectively mesh with different sets of planet gears. The plunger is spring-biased toward one end of its range of motion, and the gear shift cable is attached to allow the plunger to be pulled against the biasing spring toward the other end of its range of motion. Thus, when a user moves the gear shift lever, this pulls the gear shift cable, which pulls the sun gear to a meshing position with respect to a different group of planet gears. A ratchet or other mechanism can be associated with the gear shift lever or the geared hub to temporarily hold the cable in a selected gear position. When tension on the cable is released, the spring bias causes the sun gear to revert back to its default position, which can be the lowest gear ratio.

Advantageously, commercially available geared hubs of the type discussed above can be modified to mount to the split rim wheel halves 54a, 54b. The geared hub 66 includes two side flanges 74. As shown in FIG. 1, the left wheel half 54a includes one or more protrusions or keys 76 that are configured to interlock with one or more holes or notches in the left hub flange. The protrusions or keys prevent slippage of the rim upon the hub, so that rotation of the hub is positively transmitted to the wheel rim. The right wheel half 54b is configured to fit snugly around the right flange of the hub, and bolts 80 secure the rim halves to each other. It will be apparent that many other methods of mechanically affixing the wheel rim to the hub can be used, and that both wheel rim halves could be mechanically affixed or keyed to the hub flanges, rather than just one of the halves, as shown in FIG. 1.

Another embodiment of a split rim and geared hub is shown in FIGS. 3 and 4. This embodiment is configured for use with a geared hub having a slightly different configuration than that of FIG. 1. In this embodiment, a split collar 82, comprising semi-cylindrical collar pieces 82a, 82b, is disposed around the middle section 83 of a substantially cylindrical outer hub section 84 of a geared hub 85, between the hub flanges 86, and secured to the hub via bolts 87. The split collar sections have an inner diameter that substantially matches the outside diameter of the outer hub section, and an outer diameter that is approximately equal to the outer diameter of the hub flanges. The split collar sections thus provide an outer hub surface that is substantially flush with the outer perimeter of the hub flanges, thus effectively converting the outer profile of the hub into a smooth cylinder of a diameter equal to the outer diameter of the flanges.

Wheel rim halves 92a, 92b are then pressed onto either side of the geared hub, encasing the split collar sections 82, attached together by bolts 93. For additional strength of connection between the split collar sections and the wheel rim halves, the outer surface of the split collar sections can include a slight taper (shown in exaggerated form as dashed line 94 in FIG. 3) that rises toward the center of the wheel, so that the diameter of the split collar is slightly greater around the center than at the edges. This taper will help promote a fighter fit between the inside of the wheel rim halves and the outside of the split collar halves. The split collar sections can also include a longitudinal or annular center ridge 96, against which the wheel halves rest when fully mounted. This center ridge helps ensure that the wheel halves are fully mounted and properly aligned for rotation without wobble. Additionally, as shown in FIG. 4, a transverse keyway 98 can be provided between the split collar sections and the wheel rim sections, to provide positive engagement and prevent slippage of the geared hub and slit collars within the wheel rim. A gap or opening can be provided to allow passage of the valve stem 88 for the tire. Where a tubeless tire is used, a resilient o-ring 90 can also be sandwiched between the two wheel rim halves, to provide an air-tight seal to prevent deflation of the tire.

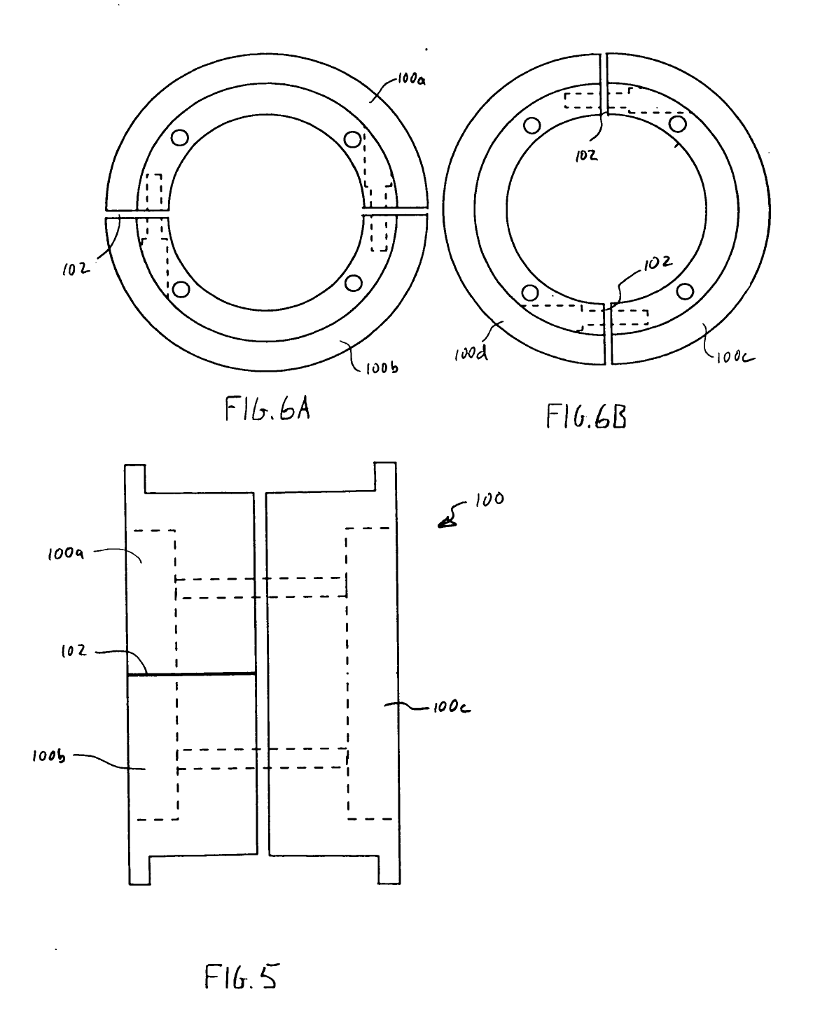

Yet another embodiment of a split rim and geared hub is shown in FIGS. 5, 6A and 6B. This embodiment is also shown configured for installation on a geared hub 85 like that of FIG. 3, though it could also be configured for use with geared hubs having different configurations. In this embodiment, the wheel rim 100 comprises wheel quarters 100a-100d, rather than wheel halves. This embodiment enables the wheel halves (each comprising two wheel quarters) to be installed inside the hub flanges (86 in FIG. 3), rather than outside the flanges, without the need for a separate split collar. Two wheel quarters 100a, 100b can be disposed around the middle section (83 in FIG. 3) of the outer hub section (84 in FIG. 3), inboard of the hub flange on one side. The wheel rim quarters are then attached together (e.g. with bolts), forming a wheel half on one lateral side of the hub. The other two wheel rim quarters are then bolted around the hub on the opposite side, inboard of the opposite flange, forming the second wheel rim half. As shown in FIG. 5, the seams 102 in each wheel half can be positioned perpendicularly with respect to one another for greater strength and balance. Bolts (not shown) can be used to secure the wheel halves to one another and to the hub in a manner similar to that described above with respect to other embodiments of the invention.

The invention thus provides a multi-piece wheel that can be secured to a geared bicycle hub, and is designed to fit small but thick tires ranging from 8″ to 12″. The invention advantageously enables light, motorized vehicles, such as gas and electric scooters, the use of a multi-speed transmission, allowing these vehicles greater efficiency and flexibility in use. Power demands can vary greatly for these vehicles. For example, when accelerating from a stop to its “cruising” speed of 25 mph, a small electric vehicle may initially draw 50 amps of power or more, the power draw decreasing as the vehicle approaches and reaches its intended “cruising” speed and the operating parameters of the motor “climb” the power curve. At the “cruising” speed the motor may be operating at, say, 3200 rpm, and drawing only 8 amps. Nevertheless, the total power consumption as the motor climbed the power curve is significant. With the present invention, however, instead of accelerating from a stop to full speed in one long draw of power, the acceleration happens in several successive stages as the user successively shifts to from lower to higher gears. In each stage, the motor will climb the power curve and reach its most efficient operating speed more quickly, thus reducing the overall power consumption for the total acceleration process.

The invention also provides advantages when encountering hills or other obstacles. When the vehicle encounters a hill, its speed may drop dramatically, pushing the motor's operation back down the power curve, to a point of drawing a large amount of power, thus dramatically reducing the life of the battery. Advantageously, with the transmission of the present invention, the user can shift to a lower gear when encountering a hill, thus allowing the motor to again operate at its most efficient speed while the vehicle travels more slowly.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A drive wheel for a small motorized vehicle, comprising:
a) a hub, having a rotational axis, and an internal transmission configured to provide multiple selectable transmission ratios;
b) a drive coupler, attached to the hub, configured to transmit a driving torque from the vehicle to the hub;
c) a split rim, having divided rim portions, coupled to the hub and configured to rotate about the rotational axis; and
d) a tire, mounted between the divided portions of the split rim.

2. A drive wheel in accordance with claim 1, wherein the internal transmission comprises an internal planetary gear system having multiple speeds.

3. A drive wheel in accordance with claim 1, wherein the transmission comprises 3, 5, or 7 speeds.

4. A drive wheel in accordance with claim 1, wherein the hub includes a pair of flanges on opposing lateral sides thereof, at least one of the divided rim portions being attached to one of the flanges.

5. A drive wheel in accordance with claim 4, wherein two rim portions are mechanically attached to the flanges.

6. A drive wheel in accordance with claim 4, wherein the split rim comprises four rim quarters, configured to attach to the hub between the flanges.

7. A drive wheel in accordance with claim 1, wherein the hub includes a pair of flanges on opposing lateral sides thereof, and further comprising a split collar, having opposing collar portions, disposed around the hub between the flanges, the split rim being configured to mount upon the split collar.

8. A drive wheel in accordance with claim 7, further comprising a transverse keyway, configured to mechanically interlock the split rim and the split collar.

9. A drive wheel in accordance with claim 7, further comprising an annular ridge, disposed approximately around a center portion of the split collar, configured for abutment of the divided rim portions thereagainst when mounted.

10. A drive wheel in accordance with claim 7, wherein the split collar includes a tapered outer surface, configured to enhance a press fit between the split rim and the split collar.

11. A drive wheel in accordance with claim 7, wherein the split collar is substantially cylindrical, and has an outer diameter at least approximately equal to an outside diameter of the flanges.

12. A drive wheel in accordance with claim 1, wherein the split rim is vertically split, comprising lateral side halves configured to attach to each other.

13. A drive wheel in accordance with claim 1, wherein the split rim is from about 3″ to about 8″ in diameter, and the tire is from about 8″ to about 15″ in diameter.

14. A drive wheel in accordance with claim 1, wherein the hub is about 3″ in diameter.

15. A drive wheel in accordance with claim 1, wherein the split rim is of injection-molded polymer material.

16. A motorized vehicle, comprising:
a) a motor; and
b) a drive wheel, including:
(i) an axle;
(ii) a hub, rotatably disposed upon the axle, including an internal multi-speed transmission;
(iii) means for transmitting rotational driving motion from the motor to the hub;
(iv) a split rim, having divided portions, enclosing the hub and configured to rotate therewith; and
(v) a tire, mounted between the divided portions of the split rim.

17. A motorized vehicle in accordance with claim 16, wherein the split rim is from about 3″ to about 8″ in diameter, and the tire is from about 8″ to about 15″ in diameter.

18. A motorized vehicle in accordance with claim 16, wherein the motor is an electric motor.

19. A motorized vehicle in accordance with claim 16, wherein the motorized vehicle is capable of speeds up to about 25 mph.

20. A motorized vehicle in accordance with claim 16, wherein the means for transmitting rotational driving motion from the motor to the hub comprises a motor sprocket, a drive wheel sprocket, and an endless chain, configured to transmit force from the motor sprocket to the drive wheel sprocket.

21. A motorized vehicle in accordance with claim 16, further comprising a gear shift device, coupled to the transmission, configured to allow a user of the vehicle to shift between the multiple speeds.

22. A drive wheel for a motorized vehicle, comprising:
a) a pneumatic tire, having a wall thickness relative to a size thereof such that mounting upon a single-piece rim via deformation of the tire is substantially prevented;
b) a vertically split rim, having separable sides configured to be mechanically fastened together to mount the tire thereto; and
c) a hub, disposed between the opposing sides of the split rim, having an internal transmission with multiple speeds.

23. A drive wheel in accordance with claim 22, wherein the transmission comprises a planetary gear system having multiple selectable gear ratios.

24. A drive wheel in accordance with claim 22, wherein the transmission comprises 3, 5, or 7 speeds.

25. A drive wheel in accordance with claim 22, further comprising a drive device, associated with the hub, configured to provide a driving torque from the vehicle to the transmission.

26. A drive wheel, comprising:
a) a pneumatic tire;
b) a substantially solid split rim wheel with opposing side portions, configured to receive the pneumatic tire; and
c) a geared hub, disposed between the opposing side portions of the split rim, having an internal transmission with multiple selectable speeds.
